(19) United States
(12) Patent Application Publication
(10) Pub. No.: US 2005/0033609 A1
(43) Pub. Date: Feb. 10, 2005

(54) Healthcare system integrated with a healthcare transaction processor, and method for providing healthcare transaction processing services

(76) Inventor: Yonghong Yang, Chapel Hill, NC (US)

Correspondence Address: NULAMBDA, INC, 116 Glenmore Road, Chapel Hill, NC, 27516, US

(21) Appl. No.: 10/911,910

(22) Filed: Aug. 5, 2004

Related U.S. Application Data
(60) Provisional application No. 60/492,617, filed on Aug. 5, 2003.

(51) Int. Cl. G06F 17/60

(52) U.S. Cl. 705/2

(57) ABSTRACT

The present invention relates to a healthcare transaction processor for reviewing and processing healthcare charge statements from the healthcare providers and claim payment statements from the healthcare payers, paying for the patient-responsible portion of the healthcare charges, and providing to the patients consolidated healthcare transaction statements that summarize (1) the total healthcare charges, (2) the payments for the payer-responsible portion of such charges by the healthcare payer, and (3) the payments for the patient-responsible portion of such charges by such third-party healthcare transaction processor. The present invention also relates to a health payment system that performs the dual functions of a conventional healthcare payer and of the healthcare transaction processor as described hereinabove.

### BACKGROUND OF THE INVENTION

1. Field of the Invention

The present invention relates to a healthcare transaction processor for reviewing and processing charge statements from the healthcare providers and claim payment statements from the healthcare payers, paying for the patient portion of the healthcare expenses to the healthcare providers, and providing to the patients consolidated healthcare transaction statements. The present invention also relates to a health payment system that performs the dual functions of a conventional healthcare payer and of the healthcare transaction processor as described in greater details hereinafter.

2. Description of the Related Art

Under most health plans and health insurance policies, the charges for healthcare services or supplies provided by a healthcare provider (e.g., a hospital or a doctor's office) can be billed to one or more healthcare payers (e.g., the insurance companies, state/federal funded healthcare systems, or self-insured employers), based on the insurance information provided by the patient at the point of service (POS). The healthcare payer adjudicates such bills to determine the amount that the payer is responsible for (i.e., the payer-responsible portion), the amount that the patient is responsible for (i.e., the patient-responsible portion). Further, the contracts between the healthcare provider and the payer may provide a volume discount for the healthcare charges imposed by the provider, or it may require the healthcare provider to write-off any claims that are denied by the payer and not to bill or charge the patient for such denied claims. Such contractual discount and write-offs are usually referred to as “Amount You DoNot Owe” in the Explanation of Benefits (EOB) statements issued by the healthcare payer to the patient, which represent the adjustment portion of the healthcare charges that neither the payer nor the patient is responsible for. After adjudication, the healthcare payer sends the healthcare provider a claim payment advice (CPA) that summarizes the adjudication results and pays the payer-responsible portion of the charges. Simultaneously, the healthcare payer sends the patient an Explanation of Benefit (EOB) statement, which summarizes the total charge imposed by the healthcare provider, the adjustment portion, the payer-responsible and the patient-responsible portions of such charges. Meanwhile, the healthcare provider may send billing statements to the patient for the charges before and/or after the adjudication process is completed.

Therefore, the patient receives two or more statements for one health transaction, and because such statements are independently issued by two different organizations (i.e., the payer and the provider) at different times, and it is difficult for such patient who has little knowledge about healthcare systems to reconcile such multiple statements. Often times, errors are found, and the patient has to contact the healthcare provider and the payer for resolution, which imposes significant burden on the patient. Further, in light of the complexity of the healthcare systems and health insurance operations, ordinary patients may not have sufficient knowledge and resource to dispute with the healthcare providers and payers. As a result, some patients overpay for the amount they do not owe, due to fear of bad credit reports, while others default on the amount they actually owe, which ultimately translates into increased health insurance premium.

Moreover, the administrative burden imposed on the healthcare providers for billing and collecting from both the payers and the patients for each health transaction is enormous. Particularly, the high costs associated with collection from individual patients after the services have been rendered have been widely acknowledged within the healthcare industry, and many have attempted to solve this problem but failed.

Credit cards or debit cards have been successfully used for providing point of service payments for a small, fixed amount of the patient-responsible portion of the healthcare charges, such as co-payments, that is known at the point of service before the healthcare payers receive the bills and conduct adjudication thereof.

However, the major fraction of the patient-responsible portion of the healthcare charges remains unknown until the adjudication process is completed when the adjustment portion and the payer-responsible portion are settled, which is usually 4-6 weeks after the service has been provided. It is therefore impossible to use the current credit card or debit card systems to pay for such unknown amount of patient liabilities at the point of service.

The Patient Easy Pay Consent form proposed by VISA® allows the healthcare provider to capture credit card information and to request written authorize from the patient for subsequent charge of the VISA® card for the patient-responsible portion of the healthcare expenses at the point of service. After adjudication, the healthcare provider uses the captured credit card information to obtain payments from VISA® for the patient-responsible portion of the healthcare expenses.

However, such retroactive charge to the credit cards or debit cards does not guarantee payments, because the credit card company automatically denies the charge if it causes the account balance for the credit/debit cards to exceed the maximum credit limit, and it is very possible that at the point of service (POS), the account balance has not yet exceeded the credit limit (therefore authorization for charges is give by the credit card company at POS) but subsequently exceeds the maximum credit limit, due to subsequent purchases occurred after the POS but before the retroactive charge by the healthcare provider is posted, which results in denial of such retroactive charge and defeats the initial purpose of using the credit/debit cards as a payment guarantee.

Further, even if the credit card company does not deny such retroactive charge and proceeds to pay the patient-responsible portion, such credit/debit transactions still give rise to significant challenges to the healthcare providers in posting the payment of the patient-responsible portion to its account receivable, because the regular credit/debit card transactions do not carry patient IDs that can be recognized by provider's billing system, and therefore cannot be posted to the provider's account receivable.

Boyer et al. U.S. Pat. No. 6,208,973 for “POINT OF SERVICE THIRD PARTY FINANCIAL MANAGEMENT VEHICLE FOR THE HEALTHCARE INDUSTRY” issued on Mar. 27, 2001 (hereinafter “Boyer”) proposes a third party payment system for providing funds for payment of the patient-responsible portion of the healthcare charges at the point of service. Specifically, such payment system comprises an adjudication engine for real-time adjudication of the charges imposed by the healthcare providers, so as to instantly settle the payer-responsible portion and the patient-responsible portion of the charges. In such manner, the credit card system can be used to pay the patient-responsible portion of the charges at the point of service, and the retroactive charging can be avoided.

However, the operatibility of such a real-time adjudication machine is questionable. Adjudication of claims is usually conducted according to patient insurance plans, provider network and pricing contracts, as well as proprietary adjudication rules implemented by various healthcare payers. Given the diverse nature of medical practice and the differences in the adjudication standards used by different payers, it is impossible and dangerous to hard code all contractual provisions and treatment rules, especially in the events that medical necessity and treatment methods are still under research and subject to controversy. While the healthcare payers continuously seek to improve the speed of claim adjudication, manual claim review by medical professionals is still a necessary and inevitable part of the adjudication process, and real-time claim adjudication, although long desired, is still not a reality up to date, much less in February 1998 when U.S. patent application Ser. No. 09/031,968, from which the Royer patent was issued, was originally filed. Without such real-time adjudication, the payment system claimed by the Boyer patent cannot perform the function that it is intended for and is therefore inoperable.

It is therefore an object of the present invention to provide a healthcare system that remedies the above-described deficiencies of the prior art system.

It is another object of the present invention to provide a healthcare system that does not require real time adjudication, but can effectively guarantee payments for the patient-responsible portion of the healthcare expenses, so as to reduce the administrative costs for the healthcare provider associated with collecting such payments from individual patients.

It is still another object of the present invention to provide a healthcare system in which the patients receive consolidated healthcare transaction statements on a periodical basis, which summarizes the total healthcare expenses, the amount paid by the healthcare payers, and the amount for which the patients are responsible within a specific time period.

It is yet another object of the present invention to provide on-line access of such consolidated healthcare transaction systems to the patients and/or the healthcare providers, which allows reorganization and extraction of payment information for tax benefits or other uses.

Other objects and advantages of the present invention will be more fully apparent from the ensuing disclosure and appended claims.

### SUMMARY OF THE INVENTION

The present invention in one aspect relates to a healthcare system, which comprises:
(a) one or more patients;
(b) one or more healthcare providers which provide healthcare services and/or supplies to such one or more patients and generate corresponding charge statements for charges associated therewith;
(c) one or more healthcare payers having contractual relationships with such patients and such healthcare providers, wherein the healthcare payers receive the charge statements from the healthcare providers, determine (1) an adjustment portion (2) a payer-responsible portion and (3) a patient-responsible portion of the charges, pay to such healthcare providers the payer-responsible portion of the charges, and generate corresponding claim payment statements; and
(d) a third-party healthcare transaction processor (HTP) having contractual relationships with the patients, the healthcare providers, and the healthcare payers, wherein such healthcare transaction processor receives the claim payment statements from the healthcare payers and optionally adjusted charge statements from the healthcare providers, pays to the healthcare providers the patient-responsible portion of the charges, periodically generates healthcare transaction statements that summarize the healthcare payers' determinations regarding the charges imposed by the healthcare providers as well as respective payments by the healthcare payers and the HTP, and periodically sends such healthcare transaction statements to the patients.

Preferably, the healthcare providers send eligibility requests to both the healthcare payers and the HTP prior to each healthcare transaction, seeking confirmation from such payer and the HTP regarding their future payments for the payer-or the patient-responsible portion of the charges, respectively. Upon receipt of such eligibility requests, the HTP verifies the fact that valid contractual relationships exist between the HTP, the healthcare providers, the healthcare payers, and the respective patient. If no such contractual relationships exit, or if such contractual relationships have expired, the HTP denies future payment of the patient-responsible portion of the charges. The HTP also reviews the balance of the account of the respective patient at the point of service, to determine whether the account balance, not including the current healthcare transaction, has exceeded a patient-accessible maximum credit limit. If yes, the HTP also denies future payment of the patient-responsible portion of the charges. Only when (1) valid contractual relationships exist, and (2) the account balance has not yet exceeded a patient-accessible maximum credit limit at the point of service, the HTP confirms its responsibility in paying the patient-responsible portion of the charges in the future.

The phrase “patient-accessible maximum credit limit” as used herein refers to a maximum credit limit that is computed on the basis of both the credit history and the medical history of the respective patient, in comparison to the conventional maximum credit limit that is computed solely on the basis of the credit history. Preferably, such patient-accessible maximum credit limit is determined by a function including terms that are correlated with the credit trustworthy of the patient, and also terms that are correlated with the periodical average medical expenditures of the patient. More preferably, such patient-accessible maximum credit limit is smaller than the conventional maximum credit limit that is computed solely on the basis of the credit history, but is larger than the periodical average medical expenditures of the patient, therefore enabling the HTP to subsequently honor its promise to pay with little or no risk to exceed the conventional maximum credit limit. Note that the medical expenditures of the patient as mentioned hereinabove only include the patient-responsible portion of the healthcare expenses, not the payer-responsible portion of the healthcare expenses.

The present invention in another aspect relates to a third-party healthcare transaction processing (HTP) system for enhancing the healthcare transaction processing efficiency of a healthcare system that comprises one or more patients, one or more healthcare providers, and one or more healthcare payers. Specifically, such third-party HTP system comprises:
(a) means for receiving claim payment statements from the healthcare payers, which specify (1) an adjustment portion (2) a payer-responsible portion and (3) a patient-responsible portion of charges imposed by the healthcare providers for healthcare services or supplies provided by the healthcare providers to the patients, and optionally receiving charge statements from the healthcare providers;
(b) means for paying the patient-responsible portion of the charges to the healthcare providers; and
(c) means for periodically generating healthcare transaction statements which summarize the charges imposed by the healthcare providers as well as respective payments by the healthcare payers and the HTP system, and sending the same to the patients.

Preferably, such third-party HTP system further comprises:
(d) means for receiving requests from the healthcare providers for confirmations regarding future payments for the patient-responsible portion of the charges thereby, prior to provision of the healthcare services or supplies to each patient;
(e) means for verifying existence of the contractual relationships between such HTP system, the healthcare providers, the healthcare payers, and the respective patient, and reviewing account balance of the respective patient to determine whether such account balance has exceeded a patient-accessible maximum credit limit, as described hereinabove; and
(f) means for responding to the confirmation requests from the healthcare providers, either confirming or denying future payments for the respective patient, based on results provided by (e).

A further aspect of the present invention relates to a healthcare system that comprises:
(a) one or more patients;
(b) one or more healthcare providers which provide healthcare services and/or supplies to the one or more patients and generate corresponding charge statements for charges associated therewith; and
(c) one or more healthcare payers having contractual relationships with the patients and the healthcare providers, wherein the healthcare payers receive the charge statements from the healthcare providers, determine (1) an adjustment portion (2) a payer-responsible portion and (3) a patient-responsible portion of the charges, pay to the healthcare providers the payer-responsible portion and the patient-responsible portion of the charges, periodically generate and send to the patients healthcare transaction statements that summarize the determinations regarding the charges imposed by the healthcare providers as well as respective payments thereby.

A still further aspect of the present invention relates to a healthcare payment system for enhancing the healthcare transaction processing efficiency of a healthcare system that comprises one or more patients, one or more healthcare providers. Specifically, such healthcare payment system comprises:
(a) means for receiving charge statements from the healthcare providers for healthcare services or supplies provided by the healthcare providers to the patients;
(b) adjudication means for determining (1) an adjustment portion (2) a payer-responsible portion and (3) a patient-responsible portion of charges imposed by the healthcare providers;
(c) means for paying the payer-responsible and the patient-responsible portions of the charges to the healthcare providers; and
(d) means for periodically generating and sending to the patients healthcare transaction statements which summarize the charges imposed by the healthcare providers as well as respective payments for the payer-responsible and the patient-responsible portions of the charges to the healthcare providers.

Preferably, such healthcare system further comprises means for establishing accounts for the patients to independently fund the payments for the patient-responsible portions of the charges. More preferably, such healthcare system further comprises (i) means for receiving requests from the healthcare providers for confirmations regarding future payments for the payer-responsible and the patient-responsible portions of the charges thereby, prior to provision of the healthcare services or supplies to each patient by the healthcare provider, (ii) means for verifying existence of the contractual relationships between said healthcare payment system, the healthcare providers, and the respective patient, and reviewing account balance of the respective patient to determine whether such account balance has exceeded a patient-accessible maximum credit limit, which is determined based on both credit history and medical history of the respective patient; and (iii) means for responding to the confirmation requests from said healthcare providers, either confirming or denying future payments for the payer-responsible and the patient-responsible portions of the charges for the respective patient, based on determinations made hereinabove.

Yet another aspect of the present invention relates to a method for enhancing the healthcare transaction processing efficiency of an existing healthcare system, by retrofitting such healthcare system with the third-party HTP or the healthcare payment system as described hereinabove.

Other aspects, features and embodiments of the invention will be more fully apparent from the ensuing disclosure and appended claims.

### BRIEF DESCRIPTION OF THE DRAWINGS

FIG. 1 illustrates a prior art healthcare system.

FIG. 2 illustrates a healthcare system comprising a third-party HTP, according to one embodiment of the present invention.

FIG. 3 illustrates a healthcare system comprising a payer/HTP, according to one embodiment of the present invention.

FIG. 4 illustrates a web-based HTP for facilitating on-line healthcare transactions, according to one embodiment of the present invention.

FIG. 5 shows an exemplary Log-In window on the HTP gateway of FIG. 4, according to one embodiment of the present invention.

FIG. 6 shows an exemplary Payer Portal on the HTP gateway of FIG. 4, according to one embodiment of the present invention.

FIG. 7 shows the Claim Search page on the exemplary Payer Portal of FIG. 6, according to one embodiment of the present invention.

FIG. 8 shows an exemplary Provider Portal on the HTP gateway of FIG. 4, according to one embodiment of the present invention.

FIGS. 9A and 9B show an exemplary Patient Portal on the HTP gateway of FIG. 4, according to one embodiment of the present invention.

FIG. 10 shows the Account Profile page on the exemplary Patient Portal of FIGS. 9A and 9B.

FIG. 11 shows the Member Claim History page on the exemplary Patient Portal of FIGS. 9A and 9B.

### DETAILED DESCRIPTION OF THE INTENTION AND PREFERRED EMBODIMENTS THEREOF

U.S. Pat. No. 6,208,973 is incorporated herein by reference in its entirety for all purposes.

The term “healthcare payer” as used herein refers to a person or a business entity that pays the cost of medical or other health care provided to a patient, which includes, but is not limited to, commercial health insurance companies, employers or organizations that provide self-funded healthcare plans to employees, and the state and federal governments that provide Medicaid and Medicare. Such term can be interchangeably used with “payer”.

The term “healthcare provider” as used herein refers to a provider of medical or other health services or supplies.

The term “patient-responsible portion” is used herein interchangeably with “patient liabilities” for specifying the amount to be paid by the patient, including not limited to, deductible amount, co-insurance amount, and co-payment.

The term “adjustment portion” as used herein refers to the portion of the healthcare charges that neither the healthcare payer or the patient is responsible for, which includes, but is not limited to, contractual discounts, write-offs, or the payments already made by other healthcare payers, etc.

The term “third-party healthcare transaction processor” or “third-party healthcare transaction processing system” as used herein refers to an entity that is independent from the healthcare providers and the healthcare payers, in comparison with a healthcare payment system or a payer/HTP system that performs the dual functions of a conventional healthcare payer and of a HTP as described hereinabove.

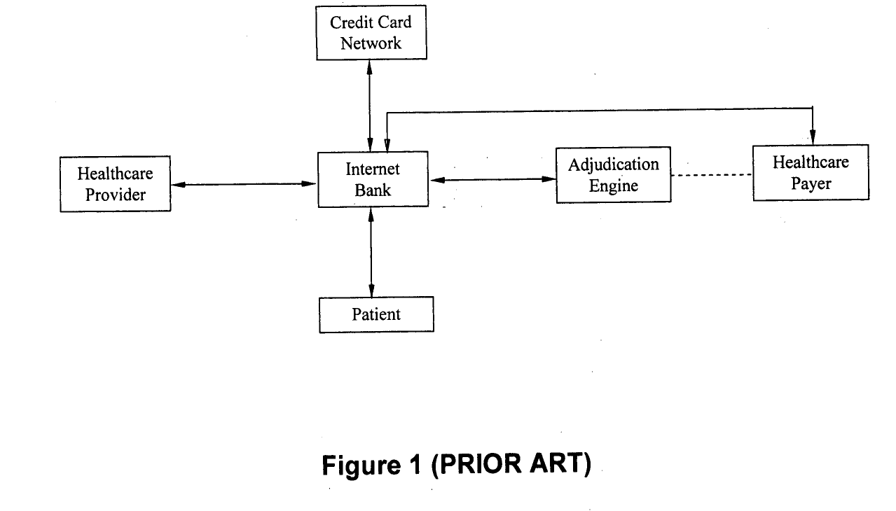

FIG. 1 shows a simplified version of the prior art healthcare system disclosed in the Boyer patent. Specifically, such prior art healthcare system comprises a payment system, designated as the Internet bank, and an associated adjudication engine, which seek to centralize all healthcare transactions used to be conducted multilaterally between provider-payer, provider-patient, and payer-patient. Such Internet bank and the associated adjudication engine rely on real-time adjudication for achieving such centralization, due to the fact that the credit card network it used for funding payments for the patient-responsible portion of the healthcare expenses requires determination of the exact amount of patient liabilities at the point of service.

However, as described hereinabove, the real-time adjudication is still inoperable. Without such real-time adjudication, such centralized healthcare system would not be able to pay for the patient liabilities through the credit card network as disclosed, and therefore would fail the purpose that it was intended for.

The present invention provides a novel healthcare transaction processor (HTP), which can be (1) a third-party entity substantially independent from the healthcare payers, (2) a payer-sponsored entity, or (3) integrated with the healthcare payers to form a payer/HTP system that performs the dual functions of the conventional healthcare payers and the HTP.

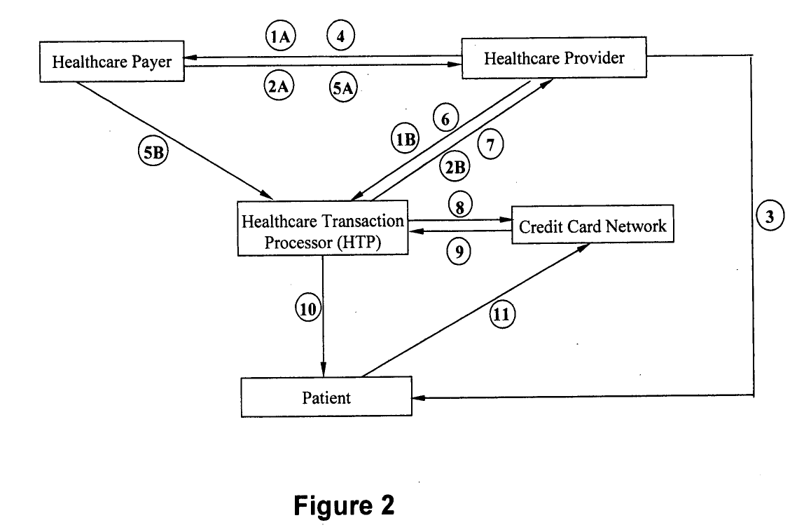

FIG. 2 illustrated a healthcare system that comprises a third-party HTP, according to one embodiment of the present invention.

The third-party HTP has established contractual relationships with multiple healthcare providers, multiple patients, and multiple healthcare payers (only one of each is shown here for illustration purposes). Specifically, the third-party HTP holds a HTP account for each patient, which contains healthcare insurance information as well as credit information of such patient. The HTP account of the patient is funded through a credit card network, e.g., a bank or other financial institution that is capable of issuing credit/debit cards and handling credit/debit transactions.

Upon each patient visit, the healthcare provider obtains insurance information from such patient regarding his or her insurance carrier(s) and HTP account. Before providing any healthcare services to such patient, the healthcare provider concurrently sends (a) an insurance eligibility request (see 1A of FIG. 2) to the corresponding healthcare payer (e.g., the insurance company) and (b) an HTP eligibility request (see 1B of FIG. 2) to the HTP, for confirmation regarding respective payments of the payer-responsible portion and the patient-responsible portion of any healthcare charges associated with this visit by the payer and the HTP.

Both the insurance eligibility request and the HTP eligibility request can be sent either through on-line application or through Electronic Data Interchange (EDI). Providers without electronic connections can simply call the payer and the HTP to request confirmation regarding the patient's eligibility. Preferably, but not necessarily, both the insurance eligibility requests/responses and the HTP eligibility requests/responses are sent in ANSI X12 270/271EDI format, as required by the Health Insurance Portability and Accountability Act of 1996 (HIPAA).

The HTP, upon receiving the HTP eligibility request, which references to the payer member ID of such patient, first determines whether such provider is effectively contracted with HTP. If no, the payment confirmation is denied. If yes, the HTP then verifies whether the payer member ID associated with the respective patient is covered by the corresponding HTP account. If no, the payment confirmation is denied. If yes, the HTP further determine whether such HTP account is expired, inactive, suspended, or delinquent. If yes, the payment confirmation is denied. If no, the HTP then proceeds to check the account balance and the remaining credit of the HTP account for the respective patient.

Although the HTP account is funded by a credit card network, it distinguishes from the conventional credit/debit transaction by: (1) having two different maximum credit limits instead of one, and (2) referencing to the healthcare payer member ID of the patient.

HTP determines a first maximum credit limit based on the credit history of the patient, by using conventional risk management analysis that is well known for a person ordinarily skilled in the credit card industry. Such first maximum credit limit is not directly accessible to the patient, but is used as a basis for computing a second, patient-accessible maximum credit limit, which is a fraction of such first maximum credit limit and a function of the average periodic medical expenditure of the patient. Preferably, the second, patient-accessible maximum credit limit is set higher than the average periodic medical expenditure of the patient, so it is sufficient to cover the normal medical expenses of the patient within the period. The average periodic medical expenditure includes only the patient-responsible portion (i.e., out-of-pocket) of the total healthcare expenses of such patient, not the payer-responsible or the adjustment portions.

The second, patient-accessible maximum credit limit is disclosed to the patient as his or her credit limit for the HTP account, and is compared to the account balance of the patient at the point of service, which does not include the current healthcare transaction. If the account balance of the patient has exceeded the patient-accessible maximum credit limit, HTP denies the payment confirmation to the healthcare provider, who may then proceed to collect any patient-responsible portion of the service charges from the patient either at the point of service or later on. If no, HTP confirms future payment of the patient-responsible portion of the service charges on behalf of the patient (see 2B of FIG. 2), and the healthcare provider can directly bill the HTP after completion of the adjudication process (see 6 of FIG. 2), therefore avoiding collection from the individual patient.

The present invention allows approval of the payment for the patient-responsible portion of the healthcare charges by the HTP at the point of service, although the amount of such payment is yet unknown. Because the approval is given on the basis of the second, patient-accessible maximum credit limit at the point of service, which is only a fraction of the first maximum credit limit as determined on the basis of the patient's credit history alone, the HTP will be able to honor such POS approval and provide full payment of the patient-responsible portion of the charges after the adjudication process is completed (which is usually 4-6 weeks after the service), even if the HTP account balance of the patient exceeds the second, patient-accessible maximum credit limit after the adjudication. In other words, the difference between the first and the second, patient-accessible maximum credit limits provides a “buffer” for the HTP to mitigate the risk that the final patient liabilities exceed the first maximum credit limit and to ascertain that the HTP is exposed only to manageable risks that are well determined based on the credit history of the patient.

Moreover, since the HTP account refers to the healthcare payer member ID of the patient, any financial transactions conducted through the HTP account are directly related to the healthcare payer account of the patient, which allows multiple members of a household who are listed under the same healthcare payer account to share a common HTP account, which provides payment for the patient-responsible portion of the healthcare expenses for all the members of the same household and generates one healthcare transaction statements summarizing the healthcare expenses for all the members of the household, while the expenses of each member can be identified separately.

Further, when the HTP account directs payment to the healthcare provider (as described hereinafter), the provider can easily post such payment to its account receivable, since such payment refers to the provider patient ID that is included in the payer CPA statement and is recognizable by the provider's billing system.

Preferably, HTP confirms future payment of the patient-responsible portion of the healthcare charges by returning a HTP payment approval code (see 2B of FIG. 2), which can be used later by the healthcare provider to as a reference to and a proof for the approval of payment for the patient-responsible portion of the charges by the HTP after the adjudication.

After the services are rendered (see 3 of FIG. 2), the healthcare provider generates a charge statement summarizing all the charges associated with such services, and transmits such charge statement to the healthcare payer (see 4 of FIG. 2) through the claim filing process that is commonly used in health insurance industry.

Upon receiving such charge statement, the healthcare payer adjudicates the associated insurance claims to determine (1) all the contractual discounts or write-offs (referred to as the “adjustment portion” of the healthcare charges), (2) the amount to be paid by the healthcare payer (referred to as the “payer-responsible portion” of the healthcare charges), and (3) the amount to be paid by the patient (referred to as the “patient-responsible portion” of the charges, which includes co-payment, co-insurance, and deductibles according to the patient insurance policy).

The adjudication results are sent back to the healthcare provider in form of a claim payment advice (CPA) statement, together with payment for the payer-responsible portion of the charges (see 5A of FIG. 2). The same CPA statement is concurrently sent by the healthcare payer to the HTP (see 5B of FIG. 2). Preferably, but not necessarily, the healthcare provider sends an adjusted charge statement to the HTP (see 6 of FIG. 2), which summarizes the patient liabilities after the adjustment and the payment by the healthcare payer have been deducted from the total charges for the services rendered. Since the adjustment charge statement from the healthcare provider and the CPA statement from the payer contain substantially the same information, the adjustment charge statement is only optional for the present invention, which may be used as a reference to the HTP to reduce potential system errors.

The HTP, upon receiving the CPA statement from the payer, and optionally also the adjusted charge statement from the provider, identifies the HTP account for the associated patient and determines whether the payment for the patient-responsible portion of the charges has been previously approved or denied in response to the HTP payment eligibility request sent by the healthcare provider at the point of service (POS). If such payment has been previously denied at POS, the HTP reminds the provider of such previous denial at POS and denies payment. If such payment has instead been previously approved at POS, the HTP then proceeds to process the CPA statement, and optionally the adjusted charge statement, for determination the patient liabilities to be paid thereby so as to fulfill the previous promise to pay at POS.

Preferably, HTP receives both the CPA statement from the payer and the adjusted charge statement from the provider, and compares the two statements for any inconsistencies. If inconsistencies are discovered, HTP contacts the payer and the provider on behalf of the patient to resolve any charge dispute. After all the inconsistencies are addressed and all disputes resolved, the HTP determines the amount to be paid by the patients according to the CPA and the adjusted charge statements.

If the patient has only one healthcare payer, such determination is straightforward. However, in some cases, the patient has contracted with two or more healthcare payers, including a primary payer and one or more secondary payers, who separately render adjudication results, pay the healthcare provider, and send the respective CPA statements to the HTP. This situation is generally referred to as coordination of benefit (COB).

The HTP in the present invention employs a primary-reversing technique for processing and consolidating multiple CPA statements from multiple healthcare payers in the event of COB. Specifically, the HTP places an electronic tag on a CPA statement from a secondary payer, which automatically triggers a search for a CPA statement from the corresponding primary payer, preferably conducted on a daily basis in batches before settlement with the healthcare provider. When the corresponding primary CPA statement is found, the HTP artificially reverses the primary CPA statement, so that only the secondary CPA statement has effect on the patient's HTP account, which reflects the ultimate amount to be paid by the HTP to the provider on behalf of the patient.

For example, for a service charge of $100, the primary payer (Payer A) sends the HTP a primary CPA statement containing the following adjudication results:

| | Total Charge | | | |
|---|---|---|---|---|
| Payer ID | Amount | Adjustment | Payer Paid | Patient Liability |
| A | $100.00 | $10.00 | $40.00 | $50.00 |

and the secondary payer (Payer B) sends the HTP a secondary CPA statement containing the following adjudication results:

| | Total Charge | | | |
|---|---|---|---|---|
| Payer ID | Amount | Adjustment* | Payer Paid | Patient Liability |
| B | $100.00 | $50.00 | $40.00 | $10.00 |

*which includes the contractual discount and write-offs according to the contract between the healthcare provider and the secondary payer, as well as payment to be paid by other payers.

*which includes the contractual discount and write-offs according to the contract between the healthcare provider and the secondary payer, as well as payment to be paid by other payers.

When only the primary CPA statement presents, the HTP posts it to the patient's HTP account, which reflects $50.00 patient liability to be paid by the HTP to the provider. However, when the secondary CPA statement presents, the HTP tags such secondary statement, identifies the corresponding primary CPA statement therefore, and artificially reverse the primary CPA statement, as follows:

| | Total Charge | | | |
|---|---|---|---|---|
| Payer ID | Amount | Adjustment | Payer Paid | Patient Liability |
| B | −$100.00 | −$10.00 | −$40.00 | −$50.00 |

Since all the numbers in such reversed primary CPA statement are negative, only the secondary CPA statement has effect on the patient's HTP account, which ultimately determines the patient liability as $10.00. The HTP accordingly removes the tag from the secondary CPA statement and process such for payment of the $10.00 patient liability.

In order to summarize the respective adjustments and payments provided by the primary and the secondary payers for the total charges, the HTP adds the reversed primary CPA statement into the secondary CPA statement to generate an adjusted secondary CPA statement, as follows:

| | Total Charge | | | |
|---|---|---|---|---|
| Payer ID | Amount | Adjustment | Payer Paid | Patient Liability |
| B | $0.00 | $40.00 | $0.00 | −$40.00 |

When generating the healthcare transaction statements for the patient, the HTP present the total payer adjustment and payment amount for each payer, as follows:

| | | Payer Adjustment | |
|---|---|---|---|
| Payer ID | Total Charge | and Payment | Patient Liability |
| A | $100.00 | $50.00 | $50.00 |
| B | $0.00 | $40.00 | $−40.00 |
| Subtotal: | | | $10.00 |

If no primary CPA statement is identified for a tagged secondary CPA statement during a particular search, the HTP posts such tagged secondary CPA statement to the patient's HTP account, and searches the incoming CPA statements for a corresponding primary CPA statement during the next search cycle.

Upon report of a fraudulent transaction, the healthcare payer will be responsible for conducting investigation, and if such fraud is confirmed, the payer reverses the claim for the patient to generate a reversed CPA statement, which is sent to the HTP and is processed thereby to reflect the changes in the provider payment and the patient's HTP account balance. Preferably, the HTP can flag the specific provider-patient combination and deny the payment to the provider up-front when the next HTP eligibility request is received from the same provider for the same patient.

After the HTP settles the amount of patient liabilities, it pays the healthcare provider the patient-responsible portion of the charges and generates a separate CPA statement for the patient-responsible portion of the charges, while such CPA statement contains the patient ID as given by the provider (i.e., the provider's file number for the respective patient) and charge/payment information associated with such provider (see 7 of FIG. 2), therefore allowing the healthcare provider to directly post such charge/payment information to its account receivable. The CPA statement can be delivered to the provider via EDI, on-line application, or mail. When on-line application is used for transmitting the CPA statement, the healthcare provider can view, print, and/or download the whole CPA statement, or a specific transaction therein. When EDI is used, the HIPAA compliant ANSI X12 835 format is preferred.

More preferably, the HTP pays the healthcare provider the total amount of patient-responsible portion of the charge minus a transaction fee, which is determined as a percentage of the patient-responsible portion of the charge.

Either before or after paying the healthcare provider, the HTP summarizes the total patient-responsible portion of the healthcare expenses and bills the credit card network (see 8 of FIG. 2) in conventional credit/debit card transaction format, and the credit card network forwards to the HTP payments that are equal to the total patient-responsible portion of the charge (see 9 of FIG. 2).

Periodically, the HTP generates a healthcare transaction statement and sends such to the patient (see 10 of FIG. 2), which itemizes the total charge imposed by the healthcare provider for each healthcare services provided during a specific time period (preferably every month), the adjustment/payer-responsible/patient-responsible portions associated therewith, the payment provided by the payer, and the payment provided by the HTP on the patient's behalf. Preferably, such healthcare transaction statement also provides the HTP account information, including the previous balance, the current charges, the last payment made by the patient, the financial or interest charges, the current balance, and the minimum amount due. More preferably, such healthcare transaction statement shows the total out-of-pocket healthcare expenses for the specific time period for each patient, so that the patient can directly submit such healthcare transaction statement to his or her flexible spending account for reimbursement or to the IRS with his or her tax return for tax deductions, or for other purposes. Most preferably, such healthcare transaction statement is accessible by the patient on-line and provides various value-added information, including, but not limited to, total charged amount, total payer amount, total discount amount, total accumulative deductible amount, total year-to-date out-of-pocket medical expenses, and total out-of-pocket medical expenses in previous years.

The patient, upon receiving the periodical healthcare transaction statement, furnishes payment to the credit card network (see 11 of FIG. 2), via conventional payment methods well known in the art. In the event that the patient has employer sponsored spending account or Health/Medical Savings Account, he or she may arrange for automatic transfer of fund from such accounts to the credit card network in payment of the balance due in the HTP account, or alternatively to the HTP who automatically substantiates the disbursement of the transferred fund. If the patient is delinquent on the payment, the credit card network or the HTP will be responsible for collection from such patient, through conventional collection methods used in the credit/debit transactions.

In a second embodiment of the present invention, a healthcare payment system is provided for performing the dual functions of a conventional healthcare payer and the HTP.

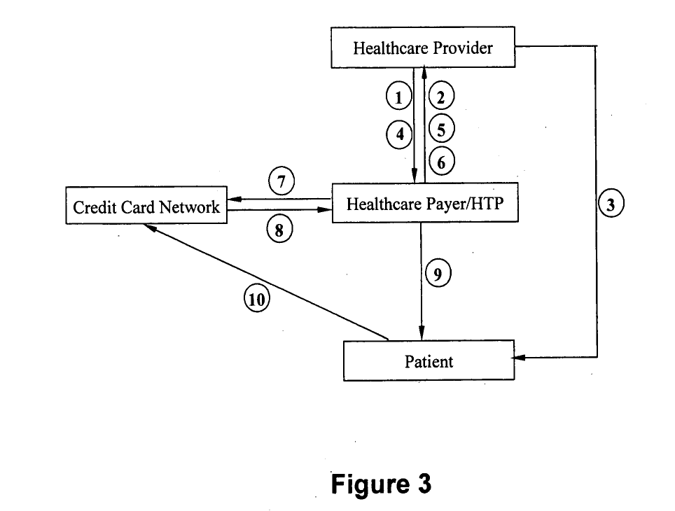

Specifically, FIG. 3 shows a healthcare system comprising a Payer/HTP system, which funds the payer-responsible portion of the healthcare charges via the conventional method, and which independently provides fund for the patient-responsible portion of the healthcare charges through a credit card network, as described hereinabove.

Such Payer/HTP system significantly simplifies the healthcare transactions, because the healthcare provider only needs to submit one eligibility request to the Payer/HTP (see 1 of FIG. 3) before providing the services to the patient, and the Payer/HTP returns confirmation regarding future payments of both the payer-responsible and patient-responsible portions of the charges (see 2 of FIG. 3). Note that such Payer/HTP evaluates the eligibility of the respective patient for payment of the patient liabilities in the same manner as described hereinabove for the HTP, and it may confirm future payment of the payer-responsible portion of the charges but deny payment of the patient-responsible portion of the charges, if the patient is not eligible for payment of patient liabilities.

After the service is provided, the healthcare provider submits the charge statement to the Payer/HTP (see 4 of FIG. 3), who subsequently pays both the payer-responsible and patient-responsible portions of the charges (see 5 and 6 of FIG. 3) to the provider and generates periodical healthcare transaction statement for the patient (see 9 of FIG. 3). Specifically, the payer-responsible portion of the charges is funded by financial resources conventionally used by the healthcare payers (such as healthcare insurance premium, etc.), while the patient-responsible portion of the charges is funded by a credit card network (see 8 of FIG. 3) upon request from the Payer/HTP (see 7 of FIG. 3).

The patient, upon receiving the periodical healthcare transaction statement, furnishes payment to the credit card network (see 10 of FIG. 3), via conventional payment methods well known in the art.

In another embodiment of the present invention, a web-based healthcare transaction processor (HTP) is provided for facilitating on-line healthcare transactions.

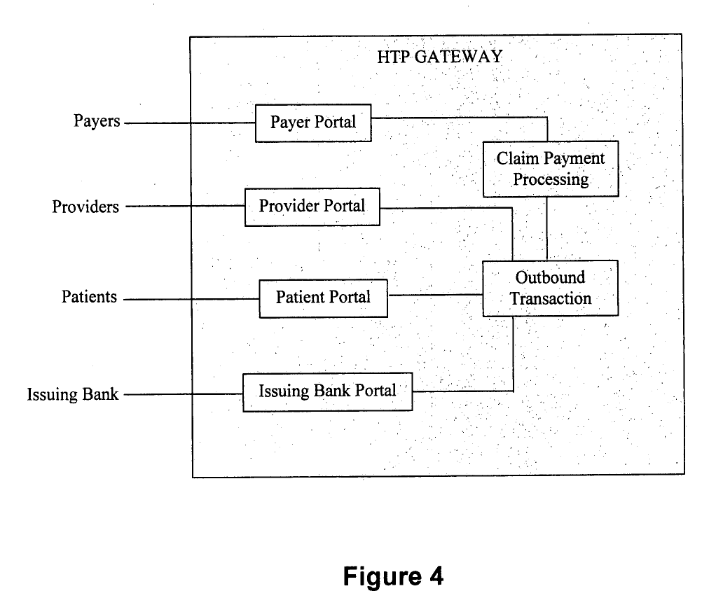

FIG. 4 shows an exemplary HTP Gateway that includes a Payer Portal accessible by one or more Payers, a Provider Portal accessible by one or more Providers, a Patient Portal accessible by one or more Patients, and an Issuing Bank Portal accessible by the Issuing Bank.

The Payer Portal allows the Payers to: (1) view and search the CPA statements posted by the HTP; (2) view and search the CPA statements posted by the Payers; (3) download and print error report or resolution report prepared by the HTP; (4) download and print business reports in forms that are specified by the Payers, and (5) conduct on-line membership maintenance by updating the HTP with any changes in the membership contracts between the Payers and the Patients.

The Payer Portal further allows the Payers to send the Payer-generated CPA statements to the HTP, preferably but not necessarily in the HIPAA compliant ANSI X12 835 format. The X12 835 file is characterized by an enveloped structure, containing (1) an ISA/IEA envelope (generally referred to as the “transmission envelope”) for isolating one group of transmitted data from another; (2) one or more GS/GE envelopes for isolating one group of similar business documents from another; and (3) one or more ST/SE envelopes for isolating one business document from another.

Once the 835 file is received by the HTP, the HTP registers the ISA/IEA and GS/GE envelopes of the 835 file as accepted and place such file in its 835 repository.

Subsequently, the HTP parses such 835 file, validates the CPA statement details stored in the ST/SE envelopes, and labels such 835 file either as accepted or rejected. For each accepted 835 transmission, the HTP sends the Payers a receipt confirmation, and assigns the CPA statement stored in such 835 transmission a processing status. For each rejected 835 transmission, the HTP sends the Payers an error massage indicating rejection of the transmission and the reasons of rejection. These steps are generally carried out by the HTP and referred to as “Claim Payment Processing” steps in the HTP Gateway.

After processing the CPA statements from the Payers and acknowledging the payer-responsible and the patient-responsible portions of the healthcare charges, the HTP pays the patient-responsible portion of such charges, generates periodically a CPA statement for the patient-responsible portion of the charge, and periodically prepares/sends to the patient the consolidated healthcare transaction statement, which are generally referred to as “Outbound Transactions” in the HTP Gateway.

The Provider Portal on the HTP Gateway allows the Providers to: (1) request and obtain payment authorization or confirmation from the HTP for the patient-responsible portion of the medical charges upon each patient visit; (2) view and search the CPA statements posted by the HTP; (3) view and search the CPA statements posted by the Payers; and (4) download and print business reports in forms that are specified by the Providers.

Further, the Patient Portal on the HTP Gateway allows the Patients to: (1) view the periodical consolidated account statements prepared by the HTP; (2) manage the HTP account via linkage to the Issuing Bank's card maintenance web-page (i.e., filing healthcare credit card application, activating/canceling credit card, applying for additional credit line, paying credit card balance, and obtaining healthcare reimbursement from the Patients' flexible spending accounts); and (3) manage the healthcare expenses, by reviewing year-to-end healthcare expense (either the general expenses or out-of-pocket expenses) slice and dice charts, comparing prices and services of various healthcare providers, preparing individual or family healthcare cost projection, and conducting financial evaluation of various healthcare insurance policies.

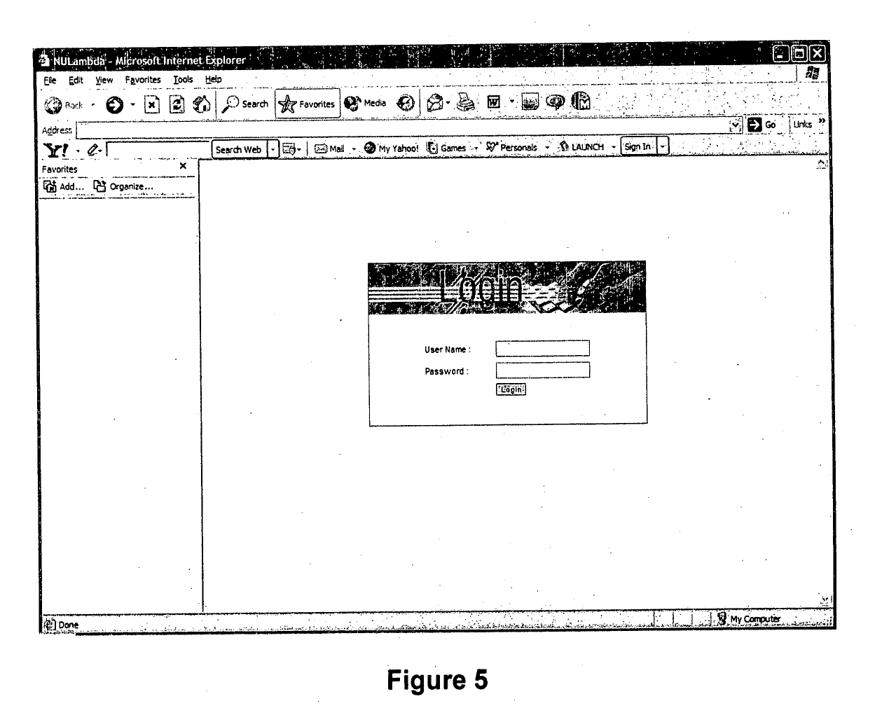

FIG. 5 shows an exemplary Log-In window for the HTP website. Each payer, provider and patient is provided with a User Name and an Password for log-in purposes.

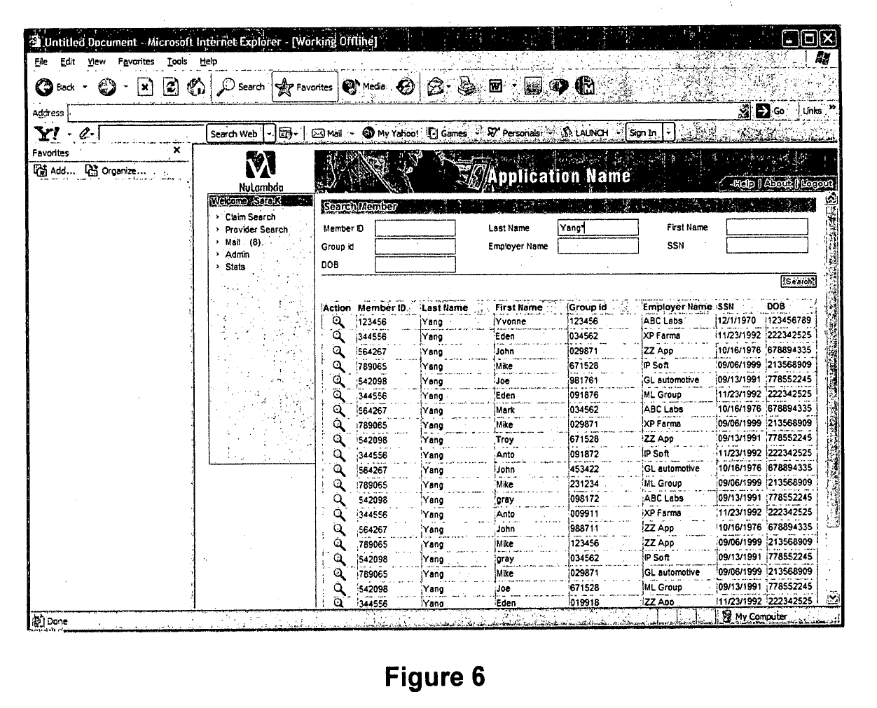

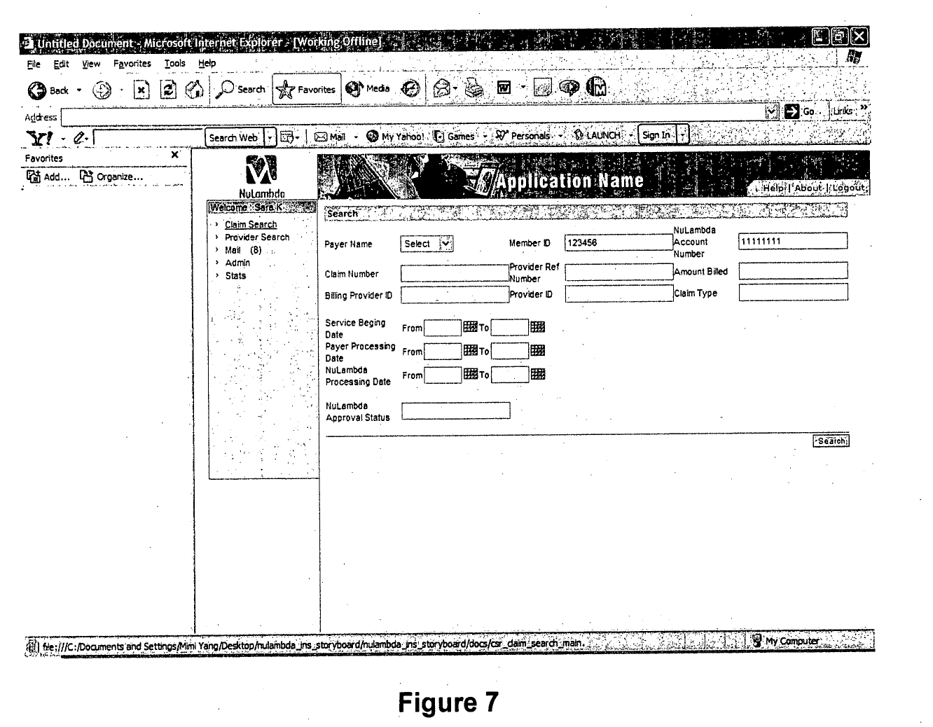

FIG. 6 shows an exemplary Payer Portal on the HTP gateway of FIG. 4, which enables at least: (1) member search, for identifying a specific member/patient having a contractual relationship with the specific payer; (2) claim search, for identifying a specific adjudicated claim (i.e., CPA); and (3) provider search, for identifying a specific healthcare provider having a contractual relationship with the specific payer. FIG. 7 shows the Claim Search page on the exemplary Payer Portal of FIG. 6.

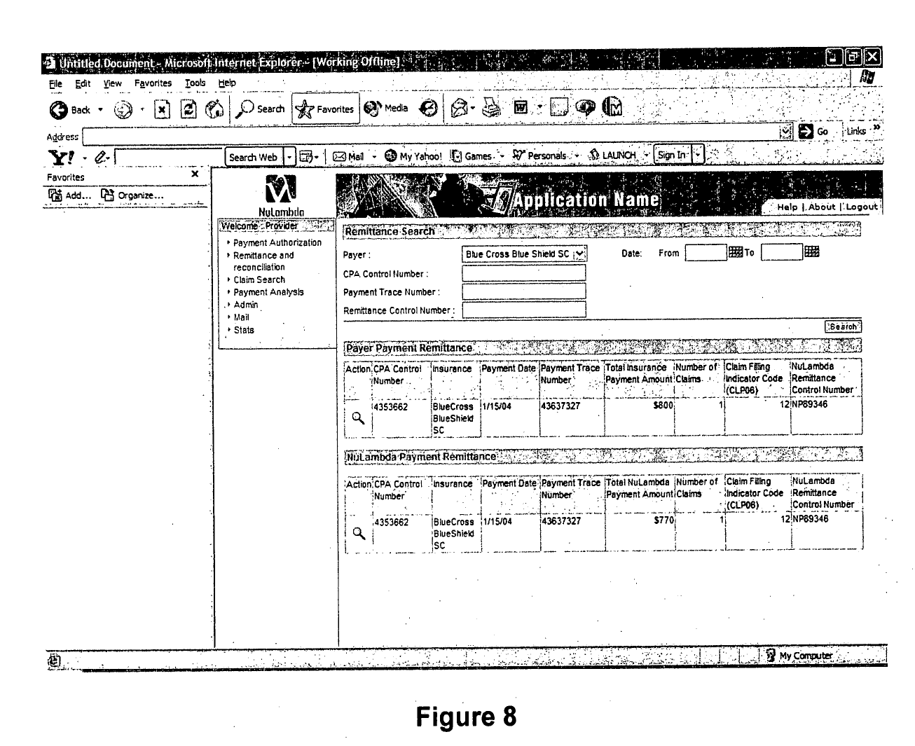

FIG. 8 shows an exemplary Provider Portal on the HTP gateway of FIG. 4, which enables at least: (1) remittance search and reconciliation, for identifying a specific remittance advice file from either the Payer or the HTP and directly posting the charge/payment information in such remittance advice file to the Provider's account receivable; (2) payment authorization, for requesting and obtaining payment authorization for the patient-responsible portion of the healthcare charges from the HTP upon each visit by the Patient; and (3) claim search, for identifying a specific adjudicated claim.

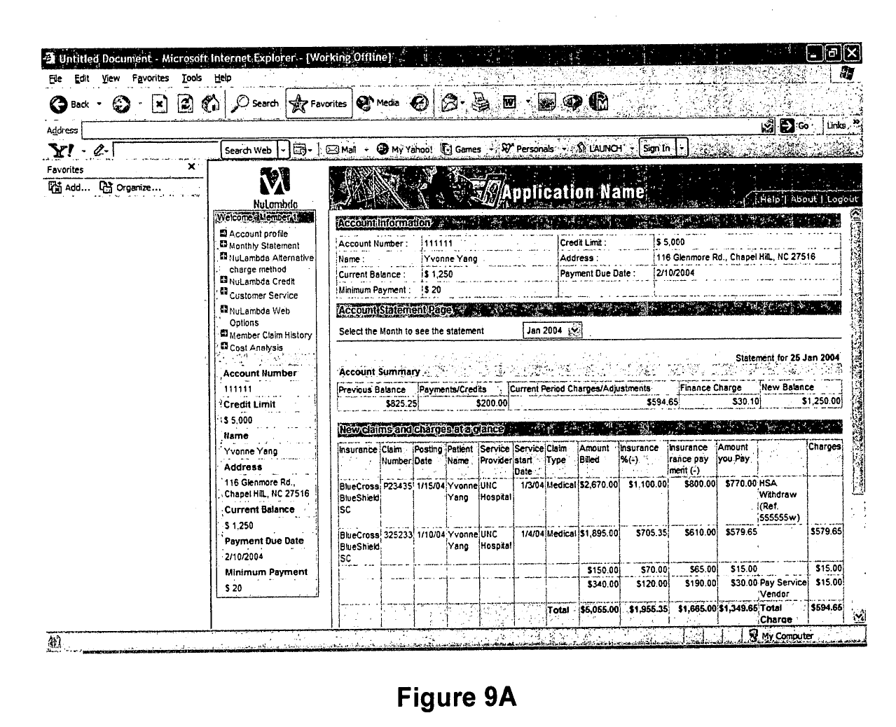

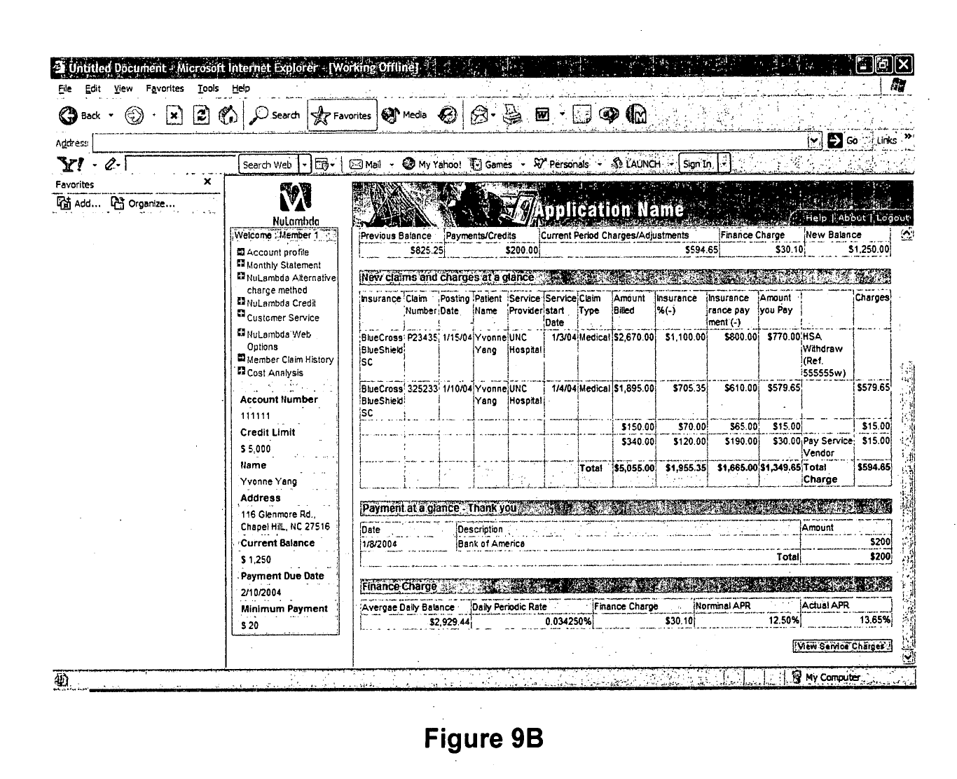

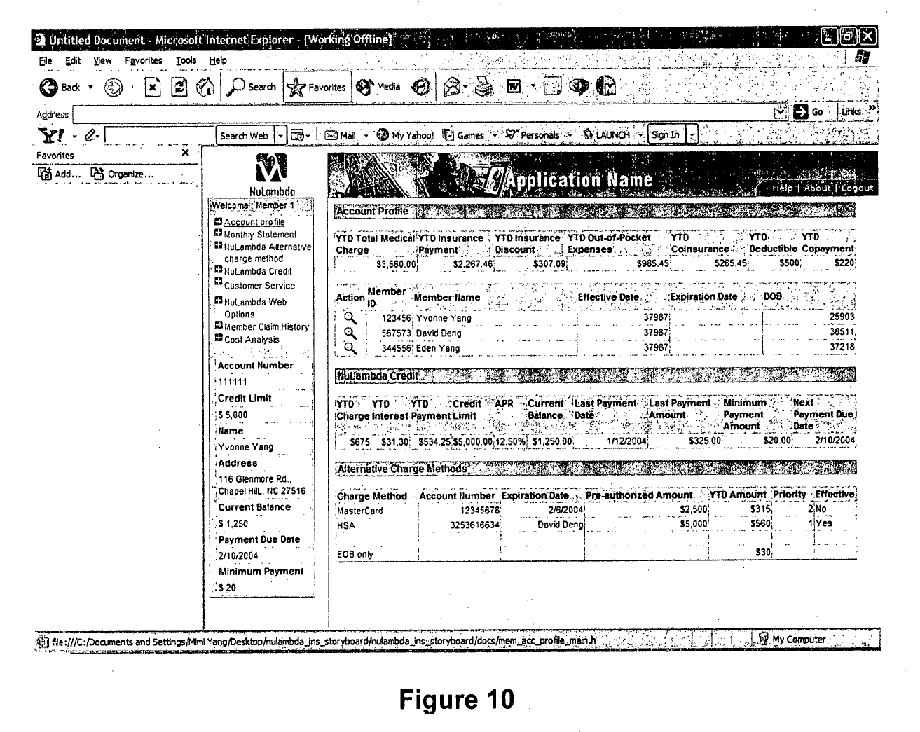

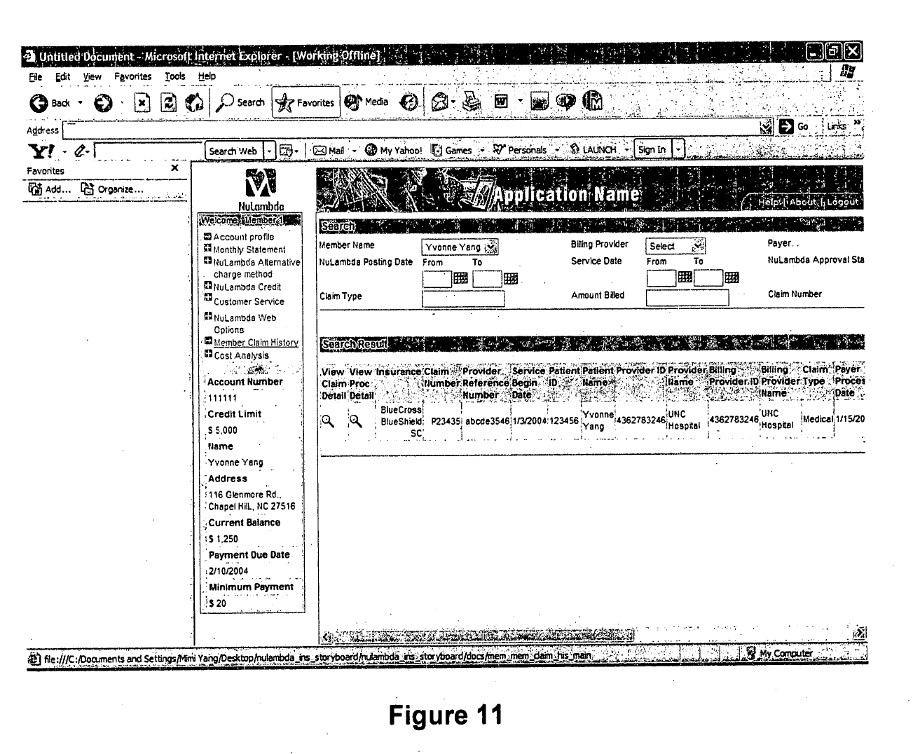

FIGS. 9A and 9B show an exemplary Patient Portal on the HTP gateway of FIG. 4, which enables the Patients to: (1) download and print account profile, monthly statement, member claim history, etc.; (2) applying for new credit card or additional credit with the Issuing Bank of the HTP; and (3) conducting cost analysis for the healthcare services provided by various Providers and the insurance policies provided by various Payers. FIG. 10 shows the Account Profile page on the exemplary Patient Portal of FIGS. 9A and 9B, and FIG. 11 shows the Member Claim History page on the exemplary Patient Portal.

While the invention has been described herein in reference to specific aspects, features and illustrative embodiments of the invention, it will be appreciated that the utility of the invention is not thus limited, but rather extends to and encompasses numerous other aspects, features and embodiments, as will readily suggest themselves to those of ordinary skill in the art, based on the disclosure herein. Accordingly, the claims hereafter set forth are intended to be correspondingly broadly construed, as including all such aspects, features and embodiments, within their spirit and scope.

1. A healthcare system, comprising:
(a) one or more patients;
(b) one or more healthcare providers which provide healthcare services and/or supplies to said one or more patients and generate corresponding charge statements for charges associated therewith;
(c) one or more healthcare payers having contractual relationships with said one or more patients and said one or more healthcare providers, wherein said one or more healthcare payers receive the charge statements from said one or more healthcare providers, determine (1) an adjustment portion (2) a payer-responsible portion and (3) a patient-responsible portion of the charges, pay to said healthcare providers the payer-responsible portion of the charges, and generate corresponding claim payment statements; and
(d) a third-party healthcare transaction processor having contractual relationships with said patients, said healthcare providers, and said healthcare payers, wherein said healthcare transaction processor receives the claim payment statements from the healthcare payers and optionally adjusted charge statements from the healthcare providers, pays to said healthcare providers the patient-responsible portion of the charges, periodically generates healthcare transaction statements that summarize the healthcare payers' determinations regarding the charges imposed by the healthcare providers as well as respective payments by the healthcare payers and the healthcare transaction processor, and periodically sends said healthcare transaction statements to the patients.

2. A healthcare system according to claim 1, wherein said healthcare providers request confirmations from both the healthcare payers and the healthcare transaction processor regarding their future payments for the respective payer- or patient-responsible portion of the charges, prior to provision of the services or supplies to each patient.

3. A healthcare system according to claim 2, wherein the healthcare transaction processor either confirms or denies the future payment for the patient-responsible portion of the charges for the respective patient, after (a) verifying existence of the contractual relationships between itself, the healthcare providers, the healthcare payers, and the respective patient, and (b) reviewing account balance of the respective patient to determine whether such account balance has exceeded a patient-accessible maximum credit limit, which is determined based on both credit history and medical history of the respective patient.

4. A healthcare system according to claim 3, wherein said patient-accessible maximum credit limit is smaller than a maximum credit limit that is determined solely on the basis of the credit history of the respective patient.

5. A healthcare system according to claim 4, wherein said patient-accessible maximum credit limit is larger than periodical average healthcare expenditures incurred by the respective patient according to his or her medical history.

6. A healthcare system according to claim 1, wherein said healthcare transaction processor funds the payments for the patient-responsible portions of the charges through a credit card network.

7. A healthcare system according to claim 6, wherein the patients make periodical payments to said credit card network for balances due that are specified in the corresponding healthcare transaction statements.

8. A healthcare system according to claim 1, wherein said healthcare transaction processor charges the healthcare providers for transaction fees that are proportional to the payments made by said healthcare transaction processor to said healthcare providers.

9. A healthcare system according to claim 1, wherein said healthcare transaction processor provides on-line access of the healthcare transaction statements to the respective patients.

10. A healthcare system according to claim 1, wherein said one or more patients include at least one patient who has contractual relationships with at least one primary healthcare payer and at least one secondary healthcare payer, wherein said healthcare transaction processor reviews claim payment statements from both the primary and the secondary healthcare payers of said patient, and determines an overall patient-responsible portion of the charges for said patient by using a primary-reversing technique.

11. A healthcare system according to claim 1, comprising multiple patients from one household who establish contractual relationships with said healthcare payers and said healthcare transaction processor as one entity and who share one account in said healthcare transaction processor.

12. A third-party healthcare transaction processing system for enhancing the healthcare transaction processing efficiency of a healthcare system that comprises one or more patients, one or more healthcare providers, and one or more healthcare payers, said system comprising:
(a) means for receiving claim payment statements from the healthcare payers, which specify (1) an adjustment portion (2) a payer-responsible portion and (3) a patient-responsible portion of charges imposed by the healthcare providers for healthcare services or supplies provided by said healthcare providers to said one or more patients, and optionally receiving charge statements from the healthcare providers;
(b) means for paying the patient-responsible portion of said charges to the healthcare providers; and
(c) means for periodically generating healthcare transaction statements which summarize the charges imposed by the healthcare providers as well as respective payments by the healthcare payers and the healthcare transaction processing system, and sending the same to the patients.

13. A third-party healthcare transaction processing system according to claim 12, further comprising:
(d) means for receiving requests from said one or more healthcare providers for confirmations regarding future payments for the patient-responsible portion of the charges by said healthcare transaction processing system, prior to provision of the healthcare services or supplies to each patient by the healthcare provider;
(e) means for verifying existence of the contractual relationships between said healthcare transaction processing system, the healthcare providers, the healthcare payers, and the respective patient, and reviewing account balance of the respective patient to determine whether such account balance has exceeded a patient-accessible maximum credit limit, which is determined based on both credit history and medical history of the respective patient; and
(f) means for responding to the confirmation requests from said healthcare providers, either confirming or denying future payments for the respective patient, based on results provided by (e).

14. A third-party healthcare transaction processing system according to claim 13, wherein said patient-accessible maximum credit limit is smaller than a maximum credit limit that is determined solely on the basis of the credit history of the respective patient.

15. A third-party healthcare transaction processing system according to claim 14, wherein said patient-accessible maximum credit limit is larger than periodical average healthcare expenditures incurred by the respective patient according to his or her medical history.

16. A third-party healthcare transaction processing system according to claim 12, further comprising a credit card network for funding payments for the patient-responsible portions of the charges.

17. A third-party healthcare transaction processing system according to claim 16, wherein the patients make periodical payments to said credit card network for balances due as specified in the corresponding healthcare transaction statements.

18. A third-party healthcare transaction processing system according to claim 12, further comprising means for charging the healthcare providers for transaction fees that are proportional to the payments made thereby to said healthcare providers.

19. A third-party healthcare transaction processing system according to claim 12, further comprising means for providing on-line access of the healthcare transaction statements to the respective patients.

20. A third-party healthcare transaction processing system according to claim 12, wherein said one or more patients include at least one patient who has contractual relationships with at least one primary healthcare payer and at least one secondary healthcare payer, and wherein said healthcare transaction processing system further comprising means for consolidating claim payment statements from both the primary and the secondary healthcare payers of said patient, and for determining an overall patient-responsible portion of the charges for said patient by using a primary-reversing technique.

21. A third-party healthcare transaction processing system according to claim 12, further comprising means for establishing a common account for multiple patients from one household who establish contractual relationships with said healthcare payers and said healthcare transaction processing system as one entity.

22. A healthcare system, comprising:
(a) one or more patients;
(b) one or more healthcare providers which provide healthcare services and/or supplies to said one or more patients and generate corresponding charge statements for charges associated therewith; and
(c) one or more healthcare payers having contractual relationships with said one or more patients and said one or more healthcare providers, wherein said one or more healthcare payers receive the charge statements from said one or more healthcare providers, determine (1) an adjustment portion (2) a payer-responsible portion and (3) a patient-responsible portion of the charges, pay to said healthcare providers the payer-responsible portion and the patient-responsible portion of the charges, periodically generate and send to the patients healthcare transaction statements that summarize the determinations regarding the charges imposed by the healthcare providers as well as respective payments thereby.

23. A healthcare system according to claim 22, wherein said healthcare payers provide accounts for the patients to independently fund the payments for the patient-responsible portion of the charges.

24. A healthcare system according to claim 23, wherein said healthcare providers request confirmations from said healthcare payers regarding future payments for the payer- and patient-responsible portion of the charges thereby, prior to provision of the services or supplies to each patient.

25. A healthcare system according to claim 24, wherein the healthcare payers either confirms or denies the future payment for the patient-responsible portion of the charges for the respective patient, after (a) verifying existence of the contractual relationships between itself, the healthcare providers, and the respective patient, and (b) reviewing account balance of the respective patient to determine whether such account balance has exceeded a patient-accessible maximum credit limit, which is determined based on both credit history and medical history of the respective patient.

26. A healthcare system according to claim 25, wherein said patient-accessible maximum credit limit is smaller than a maximum credit limit that is determined solely on the basis of the credit history of the respective patient.

27. A healthcare system according to claim 26, wherein said patient-accessible maximum credit limit is larger than periodical average healthcare expenditures incurred by the respective patient according to his or her medical history.

28. A healthcare system according to claim 22, wherein said healthcare payers independently fund the payments for the patient-responsible portions of the charges through a credit card network.

29. A healthcare system according to claim 28, wherein the patients make periodical payments to said credit card network for balances due as specified in the corresponding healthcare transaction statements.

30. A healthcare system according to claim 22, wherein said healthcare payers charge the healthcare providers for transaction fees that are proportional to the payments made thereby for the patient-responsible portion of the charges.

31. A healthcare system according to claim 22, wherein said healthcare payers provide on-line access of the healthcare transaction statements to the respective patients.

32. A healthcare system according to claim 23, comprising multiple patients from one household who establish contractual relationships with said healthcare payers as one entity and who share common accounts in said healthcare payers.

33. A healthcare payment system for enhancing the healthcare transaction processing efficiency of a healthcare system that comprises one or more patients, one or more healthcare providers, and said healthcare payment system, which comprises:
(a) means for receiving charge statements from the healthcare providers for healthcare services or supplies provided by said healthcare providers to said one or more patients;
(b) adjudication means for determining (1) an adjustment portion (2) a payer-responsible portion and (3) a patient-responsible portion of charges imposed by the healthcare providers;
(c) means for paying the payer-responsible and the patient-responsible portions of said charges to the healthcare providers; and
(d) means for periodically generating and sending to the patients healthcare transaction statements which summarize the charges imposed by the healthcare providers as well as respective payments for the payer-responsible and the patient-responsible portions of said charges to the healthcare providers.

34. A healthcare payment system according to claim 33, further comprising:
(e) means for establishing accounts for the patients to independently fund the payments for the patient-responsible portions of the charges.

35. A healthcare payment system according to claim 34, further comprising:
(f) means for receiving requests from the healthcare providers for confirmations regarding future payments for the payer-responsible and the patient-responsible portions of the charges thereby, prior to provision of the healthcare services or supplies to each patient by the healthcare provider;
(g) means for verifying existence of the contractual relationships between said healthcare payment system, the healthcare providers, and the respective patient, and reviewing account balance of the respective patient to determine whether such account balance has exceeded a patient-accessible maximum credit limit, which is determined based on both credit history and medical history of the respective patient; and
(h) means for responding to the confirmation requests from said healthcare providers, either confirming or denying future payments for the patient-responsible portions of the charges for the respective patient, based on results provided by (g).

36. A healthcare payment system according to claim 35, wherein said patient-accessible maximum credit limit is smaller than a maximum credit limit that is determined solely on the basis of the credit history of the respective patient.

37. A healthcare payment system according to claim 36, wherein said patient-accessible maximum credit limit is larger than periodical average healthcare expenditures incurred by the respective patient according to his or her medical history.

38. A healthcare payment system according to claim 34, further comprising a credit card network for independently funding payments for the patient-responsible portions of the charges.

39. A healthcare payment system according to claim 38, wherein the patients make periodical payments to said credit card network for balances due as specified in the corresponding healthcare transaction statements.

40. A healthcare payment system according to claim 33, further comprising means for charging the healthcare providers for transaction fees that are proportional to the payments made thereby for the patient-responsible portion of the charges.

41. A healthcare payment system according to claim 33, further comprising means for providing on-line access of the healthcare transaction statements to the respective patients.

42. A healthcare payment system according to claim 34, further comprising means for establishing a common account for multiple patients from one household who establish contractual relationships therewith as one entity.

43. A method for enhancing the healthcare transaction processing efficiency of a healthcare system that comprises one or more patients, one or more healthcare providers, and one or more healthcare payers, by retrofitting said healthcare system with a third-party healthcare transaction processing system as in claim 12.

44. A method for enhancing the healthcare transaction processing efficiency of a healthcare system that comprises one or more patients and one or more healthcare providers, by retrofitting said healthcare system with a healthcare payment system as in claim 33.
